(19) United States
(12) Patent Application Publication
(10) Pub. No.: US 2002/0112235 A1
(43) Pub. Date: Aug. 15, 2002

(54) Video distribution system

(76) Inventors: Bernard L. Ballou JR., Raleigh, NC (US); Kelly C. Sparks, Raleigh, NC (US); John H. Hebrank, Durham, NC (US)

Correspondence Address: Richard S. Faust, Suite 204, 8384 Six Forks Road, Raleigh, NC, 27615, US

(21) Appl. No.: 09/781,680

(22) Filed: Feb. 12, 2001

(51) Int. Cl. H04N 7/173; H04N 7/16

(52) U.S. Cl. 725/25; 725/89; 725/142

(57) ABSTRACT

Movies are distributed to customer households in a secure format on digital media such as optical disks for playback via proprietary set-top boxes. The movie disks preferably have a storage capacity enabling each disk to hold multiple movies, for example, ten, twenty, fifty or even one hundred or more movies. The movie disks are provided to customers at low cost or even no cost, and customers pay a viewing fee only when they choose to view a particular movie. A movie club model permits customers to obtain a disk each month with new release movies, and the option to order classic/older movie disks with compilations of related movies, for example, disks with twenty World War II movies or fifteen Julia Roberts movies.

### FIELD OF THE INVENTION

The invention relates to video distribution systems and, more particularly, to a system wherein movies and, optionally, other video content are distributed to consumers in a secure format on digital media such as optical disks for playback via proprietary set-top boxes.

### DESCRIPTION OF THE PRIOR ART

Widespread home television viewing began in approximately 1950 with broadcast networks transmitting shows on specific, prepublished schedules. This model remained the primary model for television viewing for over thirty years.

Cable, and later direct broadcast satellite, increased the number of channels. But viewers were still subject to programming schedules.

Video cassette recorders offered the prospect of shifting viewing times, provided the end user was one of the thirty percent or less of VCR owners who learned to program their VCR's. Even among those who learned to program their VCR, time shifting via VCR remains subject to properly setting up the timer, assuring the power is in the correct state, assuring that a correct tape is in the VCR, that the tape is not full, that the tape is properly rewound, etc. Thus, for the majority of TV viewers, even at the turn of the century, the TV viewing model has scarcely changed from the mode of 1950.

Video rental stores have provided a sort of “video on demand”, subject, of course, to the high cost of video cassette purchases by the rental stores, as well as the high capital outlay for real estate (land and building) and the cost of labor at the stores. Even when a title becomes available through video release, the viewer's ability to watch the show at his chosen time is subject to availability of the video at the store, round-trip transportation to the store and the inevitable problems with late returns, damaged videos, lost videos, etc.

True video-on-demand has been envisioned whereby massive video servers would be positioned in every geographic location to transfer high speed video data streams to the houses of individual viewers at any time a viewer wished to access a particular movie or other content. However, this type of video on demand system, after years and billions of dollars of investment, has proven to be too complex and expensive and, therefore, has not been implemented.

Another type of on-demand video distribution system is described in U.S. Pat. No. 5,832,287, whereby video-on-demand and network programming is provided from master file and network program databases through multiple community systems, each of which may serve up to approximately one hundred homes.

An interactive viewing system that automatically records selected programs is disclosed in U.S. Pat. No. 5,805,763. However, the '763 system simply provides another mechanism for recording television programs. This system attempts to simplify the VCR recording function, but because of its complex nature and limited benefits it has not been implemented.

U.S. Pat. Nos. 5,619,247 and 6,025,868 disclose a stored program pay-per-play system wherein movies are stored on storage media for later playback, with the subscriber paying only when a particular movie is viewed.

For movie distribution companies to maximize the profits from a movie, it is necessary that a large number of viewers pay to see the movie, that a reasonable price is charged, and that ancillary costs such as advertising and theater commissions be minimized. The strategy of selling movies as VCR's or DVD's in entertainment stores such as WalMart, Circuit City and Blockbuster produces a relatively low volume of sales because of the high prices associated with the outright purchase of the movies. Similarly, movie rentals realize revenues each time a movie is rented, although profits must be shared, advertising still must be done, and piracy of movies through copying rented tapes reduces revenues. Similar drawbacks exist for cable and satellite pay-per-view movie channels.

Thus, there is an acute need in the video distribution industry for a system that will provide each individual viewer with ready access to thousands of movies titles (as well as, optionally, educational programming, classic network programming, audio programming, classic sporting events, and the like) in a convenient low-cost manner that fully satisfies user demand, while enhancing the economic incentives of content providers to create and distribute an ever expanding offering of movies and other video/audio content.

### SUMMARY OF THE INVENTION

The present invention provides a video distribution system that is beneficial to both consumers and movie distribution companies (“content providers”). Consumers are free to collect and archive movies at low cost or even no cost, and later make a decision as to which movies to actually view—paying a viewing fee for those movies that are actually viewed. Consumers may view the videos at any time without restraints related to broadcasting schedules and with no need to return the videos to a rental store (although return credits may be offered). There are no late fees. New movie releases may be made available in sufficient quantities so that they are unlikely to be “sold out”, as they frequently are in existing video rental stores. Another advantage to consumers is the ultimate lower cost occasioned by the system's reduction of the real estate and labor costs associated with existing video rental stores. Because literally thousands of movies may be made available, the video distribution system of the invention may provide a greater selection than existing video rental stores. The invention may also provide improved access to content for those who live in geographically remote and/or sparsely populated areas that may presently have little or no access to video rental stores. In certain embodiments, the present invention also provides the ability to update movie pricing at any time, for example on a daily, weekly or monthly basis, so that consumers can choose to view movies at times when content providers offer pricing specials or incentives.

Content providers recognize a very significant benefit in that they receive income every time a movie is played, thereby creating significant residual value for their investments. Importantly, new release movies may be made available in large numbers during initial peak demand when pricing power is the highest. The mentioned residual value translates into increased income for the content providers because a significant portion of existing content is available for viewing every day. The invention may be carried out in such a way as to allow content providers to change pricing at any time, e.g., daily/weekly/monthly, to optimize price vs. consumer demand. This provides an extremely high benefit by effectively allowing the market to clear (i.e., real demand matches supply), something that the current video distribution model (TV, movie channels, cable/satellite pay-per-view, DVD clubs and video rental) do not provide.

More particularly, the present invention employs a strategy for maximizing revenues to content providers by creating a large number of viewers who pay a fee each time they view a movie, and relies on an extension of word-of-mouth advertising, customer archiving of movies and other means to maximize the number of viewings.

This system distributes movies in the form of digital movie disks that can only be played on a low-cost set-top box that monitors and invoices/debits viewers each time a movie is played on a box. In preferred embodiments, movies are stored in compressed form on digital media that have sufficient storage capacity to store multiple compressed movies, for example, 2 to 10 movies, or up to 20, 50 or even 100 movies or more. In one embodiment consistent with the invention, the digital media are in the form of near-field optical disks substantially as described in U.S. Pat. Nos. 5,910,940; 6,094,413 and 6,115,348 and the attached Appendix A, IDC White Paper entitled “Calimetrics' Multilevel Technology Enables High-Performance CD/DVD Recorders”, IDC, Framingham, Mass., USA (2000), incorporated herein by reference. Near-field disks may be produced at about the same size and of the same or similar material as conventional music or computer CD's or DVD's. Near-field technology allows more data to be placed on a disk by incorporating internal lenses that reduce the effective size of a laser spot allowing half the track pitch of a DVD and shorter inter-pit distances along the track than a normal DVD. A normal DVD holds about 4.7 gigabytes of information, a two-sided near-field disk the same size can hold about 20 gigabytes of information. With refinements, near-field disks may hold more than 100 gigabytes of information as shorter wavelength lasers become available and other technologies such as multi-level (ML) DVD technology are combined with near-field technology. ML technology has been developed and has been commercialized by the ML Alliance, comprising Calimetrics, Inc. of Alameda, Calif., USA; TDK; Mitsubishi Chemical; and Plextor. The ML technology is described in U.S. Pat. Nos. 5,235,587; 5,818,806; 5,854,779; 6,115,348; 6,148,428; and 6,150,964, incorporated herein by reference, and the attached Appendix A.

Data can be placed on near-field disks by writing or pressing, similar to CD RW or pressed CD's. The cost to create a pressed CD is about $0.20 and the cost to produce a written CD is closer to the cost of the media or about one dollar per disk. The estimated cost of a two-sided near-field disk created by pressing is about twice the cost of pressing a single-side CD. Because current video compression technology allows a VHS quality movie to be stored in less than 2 gigabytes, the cost of storing ten movies on a 20 gigabyte near-field disk would be about $0.50 or about $0.05 per movie (plus shipping and handling).

Reading a pressed near-field disk can be both low-cost and proprietary due to the similarity of these readers to mass-produced DVD players. As described in the above-mentioned U.S. Pat. Nos. 5,910,940; 6,094,413 and 6,115,348 and the attached Appendix A, modifications to a DVD player to read an near-field disk includes slight modifications to the distance between the optical head and the disk, and an additional chip (or additional functionality on the servo chip) to properly recognize the near-field track and read all the data on a side.

It is particularly important to the business system described herein that disks are readable only on viewing systems that can monitor, control and bill based upon the number of movies viewed. The requirement of having to track the near-field spiral assures that a special purpose chip, or special modifications to the servo chip are needed to read the disk. Furthermore, header codes can be placed in disks during manufacture, for example in the wobble-track, to assure that only readers containing the proprietary tracking chip read these movie disks. Additionally, the video material on the disk can be encrypted by any number of conventional or unconventional methods to assure that a digital copy of the movies is not available to pirates.

The reader/player box must also be able to monitor, control and charge the customer based upon the number of plays of a movie. This may be done in a number of ways. In certain preferred embodiments, the player communicates the playing of a movie, the movie's ID and the viewer ID to the system operator's central computer system on a real-time, daily or weekly basis over a cell or a normal telephone connection. Alternately, credit may be communicated to a box by a mag strip, an external communication strip, an internet connection or other suitable means. Credit may be extended to a reader box, or viewer prepayments may allow viewing multiple movies without having to initiate a billing operation.

Multiple distribution systems for the movie disks are possible, including club mailings to members; sale at local movie rental stores (e.g., Blockbuster), convenience stores or large retail stores (e.g., Walmart); loans or transfers of disks from friend to friend; as part of a purchase of a reader box; or random mailings. Various of these methods have may advantages of scale. The distribution methods may also make use of known customer profiles in order to target different niches of customers. Because revenues may be realized from this system at two different points, the original sale of disks and the playing of movies, prices can be adjusted to encourage distribution through different markets. For example, bulk pressed disks may be sold to a Quickie Mart convenience store for $0.50 a disk with the Quickie Mart selling the disk for $1.00, and the system operator might receive an average of $2.00 a movie per play. The system operator may find it advantageous to reduce the price of bulk disks to stores to encourage more aggressive marketing and increase the per-play revenues.

An optional additional feature of the system is the use of identification tags on pressed movie disks that identify the seller of the disk and allow rewarding the original seller of the disk. Such identification tags may be read by a the disk reader, a bar code reader internal or external to the player, or by the person requesting to view the movie.

There are also multiple ways of setting and communicating the per-play price of a movie. This information may be written on the outside of the disk, or the player may reference the movie ID number to an internal database and communicate that value to the viewer via the TV screen. Similarly, if the system uses special credit cards to play a movie, similar to phone cards now sold, then these cards may contain the rates for different movie categories and viewing periods.

The system allows the value of movies to change over time, e.g. during the first week after release a movie may cost $10.00 per play, then revert to $2.00 per play, and finally after it is several years old, perhaps $0.50 per play. This can be accomplished by a date code on the disk and a clock in the player, and appropriate price schedules on the disk for each movie or downloaded from a central system at the time of playing.

The movie distribution and customer movie archiving models of the present invention offer the opportunity for the system operator to offer both new release movies and classic/older movies through a movie club. Upon joining the club a member receives a reader box if he does not already have one and thereafter, on a regular basis such as monthly, receives a single multi-movie disk (or two or more disks, if necessary) that contains the new release movies for that time period. Preferably, the cost of pressing the disks and shipping/handling are covered in whole or substantial part by the member's dues to the club, although free distribution of the new release disks may be justified in the case of members who have a recent history of frequent pay-per-view use of the system. The shipment of the monthly new release disks may be timed so that some or all of the movies on the disk are available to members before the movies are available at video rental stores or through cable/satellite pay-per-view or cable/satellite movie channels. Members are free to watch the movies as desired with payment to the system operator being made according to one of the billing scenarios described elsewhere herein. The monthly disks are archived in the member's movie library so that over time the monthly disks alone create a substantial library. In addition to monthly movie disks, members may order disks containing multiple classic/older movies that appeal to the member, for example, a disk containing all of the James Bond movies or a disk with ten Julia Roberts movies or twenty World War II war movies, or several disks containing all new release romantic comedy movies from the last three years (or any time period). These disks are also available at low cost or even no cost to approved members. Thus, a member can easily, quickly and at low cost assemble a personalized movie library with hundreds of titles. All of the movies are always readily accessible and ready for playing, resulting in vastly improved viewing choices for members, a vast new source of income to content providers for residual properties, and a steady flow of income to the system operator and related parties.

### BRIEF DESCRIPTION OF THE DRAWINGS

Some of the features of the invention having been stated, other features will appear as the description proceeds, when taken in connection with the accompanying drawings, in which

FIG. 1 shows video distribution system components in a customer household connected to the central controller of the video distribution system operator.

FIG. 2 is a block diagram of the primary components of the movie disk reader box shown in FIG. 1.

FIG. 3 is a chart illustrating a sample transaction between a customer's reader box and the video distribution system operator's computer.

FIG. 4 is a block diagram of one simplified embodiment of a business model for commercializing a video distribution system consistent with the invention.

FIG. 5 is a block diagram of another business model that utilizes distributors to distribute some substantial portion of the movie disks to consumers.

### DETAILED DESCRIPTION OF THE INVENTION

While the present invention will be described more fully hereinafter with reference to the accompanying drawings, in which aspects of the preferred manner of practicing the present invention are shown, it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

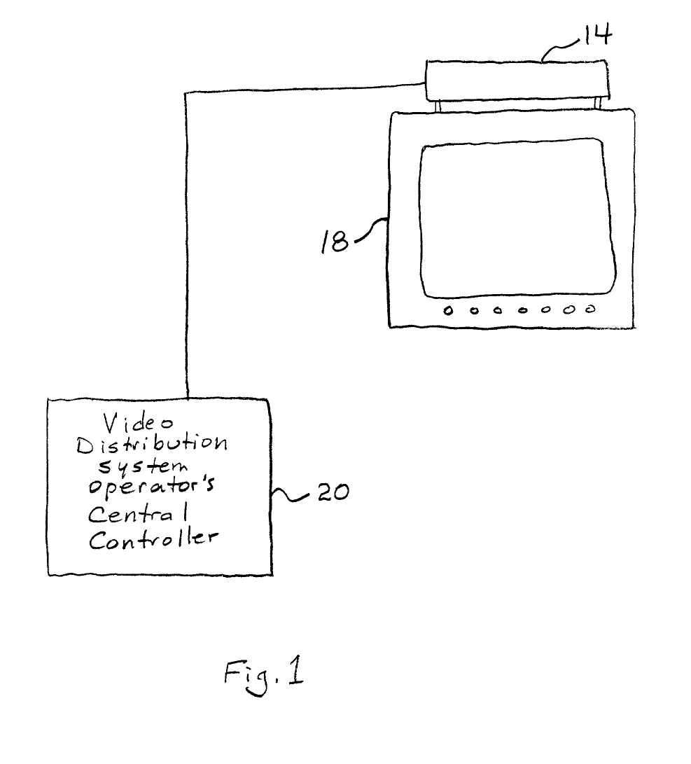

FIG. 1 is a diagram of the video distribution system components in a customer household. These components include a movie disk reader in the form of a play-only set-top box 14 for playing proprietary disks that are distributed in accordance with the invention. Set-top box 14 is connected to a video display device such as television 18. Box 14 is also connected to the central controller 20 of the video distribution system operator.

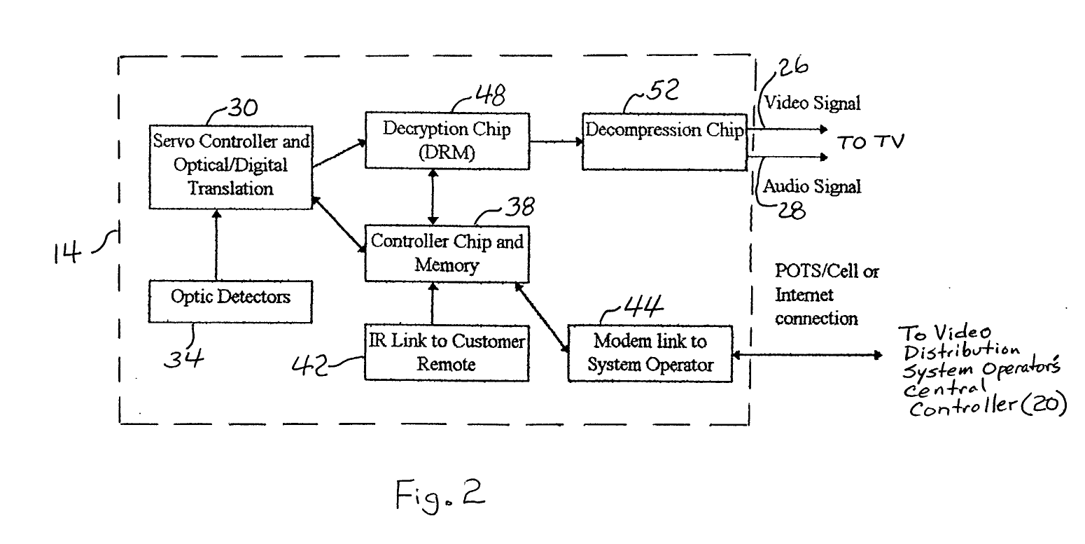

Box 14 has the capability to communicate with central controller 20 to conduct billing transactions resulting from movie playback on the box (or simple extension of “credit” to the box) and to communicate other information as described in detail elsewhere herein. This communication may be accomplished through modem 24 (FIG. 2) that is connected to a standard POTS phone line, a DSL or ethernet port connected to a digital network or an internal cell phone. In the future, the communication may be possible by transmissions from box 14 to central controller system 20 via satellite. Similarly, where appropriate, box 14 may use the communication capabilities of the customer's satellite or cable box to achieve connection with the central computer system.

FIG. 2 is a block diagram of the primary components of set-top box 14. Box 14 has outputs 26, 28 to a TV, although portable movie disk reader boxes may contain their own screen and speakers or headphones. Box 14 contains optics and optoelectronics similar to a DVD reader. The servo controller and optical/digital translation chip 30 (servo chip) powers the motor, spins the disk and provides radial and head positioning signals. Signals to steer the servo come from a conventional quad detector DVD optical detector system 34 that allows tracking by comparing the intensities of the signals received by multiple detectors. Unlike a normal DVD, near-field disk tracking requires finer resolution of signals from multiple tracks. This system of reading near-field disks is detailed in the attached Appendix A and U.S. Pat. Nos. 5,910,940; 6,094,413 and 6,115,348. A controller chip and memory module 38 instructs the servo to move to tracks containing the material to be viewed. Controller chip and memory module 38 also conducts accounting, digital rights management (DRM) and communication functions with both the viewer and the video distribution system operator. Viewer information is communicated through messages sent to the TV screen (or audio channel if voice synthesis is included) and viewer responses are received through an infrared (IR) link 42. Communication with the video distribution system operator may be conducted at daily or weekly intervals and occurs over a modem link 44, or alternatively, via an internet or credit card connection, or other suitable means. The memory of module 38 allows it to store billing and DRM information.

Movies are both compressed and encrypted. A decryption chip 48 for DRM does decryption and a decompression chip 52 converts the compressed video and audio to viewable movies.

Digital Rights Management

Protection against piracy and unpaid viewing is keenly important to the content providers. Piracy protection may be accomplished at several levels within the system. First, preferably the media and disk readers are nonstandard and proprietary. For example, the near-field disks described above cannot be read by a normal DVD player or DVD computer drive due to the higher densities, closer track pitches of the disks and slightly different optics of this system.

Second, each movie preferably is encrypted before storage by a proprietary encryption scheme that requires multiple pieces of information to successfully decode a movie. Each digital rights management (DRM) decryption chip 48 has a unique identification number. (In some designs of the system where the decryption chip and controller chip are linked in such a way so that hackers cannot monitor data flow between the two chips, such as by potting, the controller chip may contain this unique ID number.) Additionally, when movie disk reader box 14 contacts the computer of the video distribution system operator by modem (or otherwise), a second unique identification code is transmitted to the system operator that allows the system operator to look up the individual box's DRM code number. Using this code number and a transaction number (or random number) from box 14, and remembered by the box, the system operator creates a DRM code and sends that back to box 14 along with instructions for the amount of available credit that the box can draw upon before having to reconnect with the system operator. Thus, knowing a general DRM code will not work with individual boxes, and knowing a DRM code specific to one box will not work sequential times since the box changes and transmits a new transaction number to the system operator each time credit is applied for. Thus for a controller/DRM to successfully decode a movie they must know a code that is unique to the chip and unique to a number that the chip generated and sent to the system operator.

A third level of protection may be acquired through a proprietary compression algorithm. The algorithm may be a variation on a common decompression algorithm or even may be specifically developed in its entirety for this purpose. Additionally, the algorithm may also have aspects of decompression that allow a form of watermarking to be done on the video and/or audio of a movie. The watermark may allow some level of determination of what box or disk a movie originated from in the event that movies are recorded from the analog data stream sent to the TV monitor.

Communication Between a Box and the System Operator

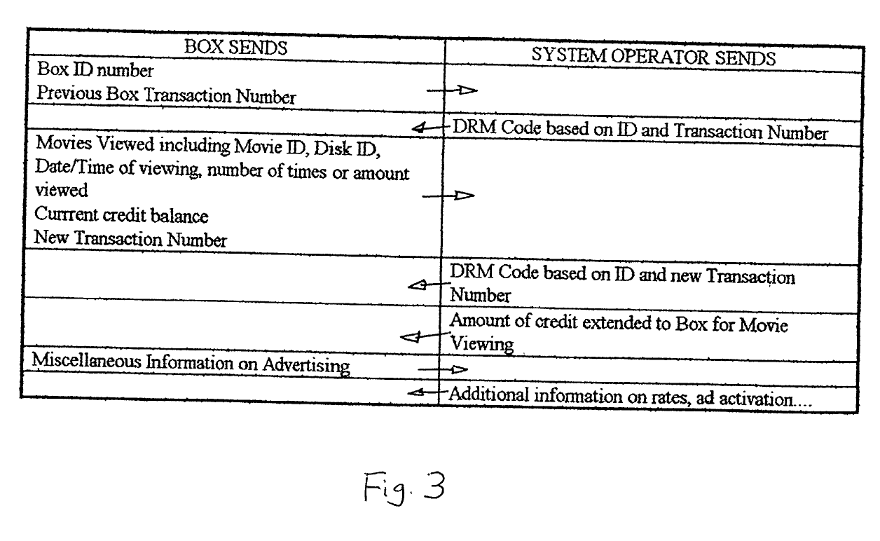

Communication between movie disk reader box 14 and the system operator may accomplish several functions, some of which are optional: extension of credit to the box so that multiple movies may be viewed before having to connect again; accounting from the box to the system operator to let the system operator know what movies have been watched for properly crediting a viewer's account; acknowledging the distributor who supplied the disk; compensating the content providers for their movie that was watched; and refreshing the box's DRM codes as previously discussed. A typical communication between a movie disk reader box and the system operator's computer is detailed in FIG. 3. Note that after the system operator and box have established that each other are both part of the system and achieved communication, the box uniquely identifies itself with its ID number and the last transaction number that it had previously sent the system operator. Cross validation can occur by the system operator regenerating and resending the DRM code that was previously generated for this box ID and transaction number. Once positive identification is confirmed, the box can send movie viewing information including the ID's of the movies viewed and their disk ID's (should the system be set up to reward distributors of disks), the date/time that each movie was viewed in the case that part-day pricing be in effect, the current credit balance, and finally a new box-generated transaction number. The system operator then sends back to the box a new DRM number based on the new transaction number, and a new credit balance. Depending upon the method of charging for partially viewed movies that information may also be sent to the system operator. Similarly, if the system is adapted to interactive advertising this information may be sent to the system operator (or new advertising material may be sent to the box).

Special box/system operator communication may occur as a part of interactive advertising placed on a disk, or for special billing situations such as an extremely recent movie where the per-view fee is changing.

Communication is typically initiated by the box in order to refresh its credit, update current movie cost structures or to do a routine check-in.

Playing a Movie Disk from the Customer's Point of View

A person who wishes to watch movies from the system typically begins the process by going to a store that sells system-authorized movie disk reader boxes. The box may come with several disks of recent movies with labels on them indicating what movies are on each disk. The activation process begins by the customer calling the system operator's phone operator and giving their name, phone number, billing address, a credit card number and the serial number of the box they have just purchased. Optionally, there may also be an agreement about the amount to be prebilled to the credit card and limits of credit extended to the box. The customer also selects a personal identification number (PIN) for the box and can have a PIN for each person using the box.

The next step is to plug in the box and allow it to contact the system operator via a modem connection through the user's phone, its internal cell phone or via an internet connection. When the box connects to the system operator it sends its ID number and a transaction number. In return the box receives an amount of credit extended to the box, a DRM key, a short file that lists current exceptions to the pricing rules, and a file that indicates special rates available to the customer for particular movies based upon the number of times the customer has previously viewed the movie.

The above interaction may be done with a TV connected to the box or without the TV.

Next the customer connects the reader box to a TV set (and plugs the box into a wall socket for power). Note that in this embodiment, connections to the phone or internet only need to be done when credit is low or when a new user is authorized to use the box, such as in the case where a box is sold or given away or another member of the family receives their own PIN and credit account.

To watch a movie from a disk, the customer turns on the TV and inserts the disk in the reader box. On a menu system the TV displays the titles of the movies on the disk, as well as the current prices in effect for each movie. The credit available in the viewer box is also displayed. Movies may be different prices depending upon which pricing category the movie is coded for. If there is a promotional sales price for a particular movie or if the system operator provides discounts for movies that the customer has viewed before, the box indicates a revised price for that movie. In this embodiment, the number of viewings of each movie is information that resides in the box and also in the system operator's database that can be downloaded to any new box that is put into use. Depending upon a customer's billing plan, family members may get per-play discounts based upon anyone on the account viewing a movie. Other billing plans may not make each user aware of movies watched by other users.

Using the IR remote, in preferred embodiments the customer can navigate the menu and find out more about each movie on the disk such as a review, actors or even view a trailer for a movie. Interactive ads may also be available, for example, other Dustin Hoffman movies on other disks may be advertised, or reference to a franchised marriage counseling service may be provided with local phone numbers. In case the customer is interested, the interactive ad may yield a short course on the marriage counseling process. After selecting a movie, the movie begins to play. At any time the customer can pause the movie, and, to a limited extent, replay portions of the movie in case of a brief unexpected interruption. Should the movie be totally interrupted, perhaps by a power outage or a neighbor dropping in, sufficient credit may be extended that allows the customer to finish viewing the movie at a later time, perhaps any time in the next seven days. These rules are covered in the billing plan that the particular customer selects and can be reviewed on the screen at any time.

When the movie is finished the customer can retrieve the movie disk from the reader box and place it in his library or give it to a friend. The record that a customer has watched a particular movie is stored in the reader box and will be uploaded to the system operator's central computer the next time the box is connected for communication to the system operator.

After having watched several movies, the reader box will let the customer know his credit balance the next time it is turned on. Should the credit extended to the box be low, reconnection to the system operator's computer can be used to refresh the credit. Should the box be lost or damaged, a phone call to the system operator will let the customer deactivate that box from his account and any remaining credit in the box can be returned to the customer's account. If the customer does not reconnect the box to the system operator's computer for more credit, the box only allows the customer to view free movies, menus and ads on a disk. If a person owns several boxes, typically credit must be individually extended to each box.

It will be appreciated that in addition to having the ability to play movies using the system operator's disk format as described above, reader boxes of the invention may also be provided with the ability to read a number of other disk formats such as DVD, CD, CDR and CDWR, as well as a number of data formats such as DVD VOB file formats, PCM (standard CD formats), Microsoft audio and MP3 files. These additional reader capabilities provide a more versatile and useful set-top box for consumers who may desire these features.

Pay-Per-Play Options

Many pay-per-view pricing options are possible with the system of the invention.

Typically, each movie disk contains a data table that indicates the pricing category for each movie on the disk. The category for each movie is established by the content provider prior to production of the disk. Categories may range from “recent blockbuster” to “old one-star”. In some cases a movie may be listed in several categories with start dates for each category. Pricing categories may have generic names, but may also merely be pricing structures that different movies are listed under.

Within non-volatile memory in the reader box are two other pricing tables. The first table, the standard pricing table, lists the pricing rules for each movie category for this customer. For example, a customer who is a member of the “System Operator Movie Club” might have a per-play price for an “old one-star” as $0.20 per play declining $0.05 for each play, and a pay-to-own price of $0.85. Another customer might have a completely different pricing table based upon his viewing history or the plan that customer entered with the system operator. The second table lists “Exception Pricing”, and all or part of it may be updated with each connection to the system operator. Exception pricing lists individual movie prices that override the standard price structure. Exceptions may include sales or promotions on recent movies or movies that have new prices based upon viewer history. For example, after a customer's child has watched “Babe, The Pig” for the tenth time, that movie can be played on this particular box without further charge. Note that the Exceptions Pricing table may be updated by the system operator's computer based upon movie viewing data that is uploaded from the box to the system operator's computer in the same transaction.

From the customer's point of view there are several different per-play options. The simplest option is to watch a movie for a per-play amount listed in the disk menu. The customer may notice or even be told in the menu screen when a movie declines in price because it has been viewed one or more times previously on this box or account. A customer may even choose the option of buying the movie so that when this movie is selected, there will be no per-play fee. This option is particularly appropriate for children's movies where a disk can be left in a player and a child can activate a movie by choosing it from the screen. A purchased movie can be viewed without having to enter a PIN number, and under certain plans, a purchased movie can be played on another reader box provided a special purchaser ID code is entered via the user's remote. Other purchase options may include buying rights for unlimited views of a movie over a certain period of time, for example, two days or a week.

Billing Options

As described above, certain embodiments of the invention involve the reader box communicating with a computer of the system operator to receive credit at the box based upon an account established with the user of the box and the system operator. In these embodiments, preferably DRM keys are downloaded for use when credit is extended to the box form the central system.

Alternative embodiments are possible for situations in which regular connection to a central computer system is not easily possible or not desirable. Examples of these situations include portable players for use to play movie disks in cars, public players on airplanes and players included with the rental of a vacation home. Other examples include individuals who are adverse to using the system operator's central computer system or who do not possess a charge card for transferring money to the central system. In these situations, activation cards can be purchased by system customers in a store, like phone cards, and communicate a standard pricing structure and available e credit to the customer. Pricing structures may also be stored in the player. Credit on such cards is billed (reduced) at the start of each per-play viewing.

Business Models

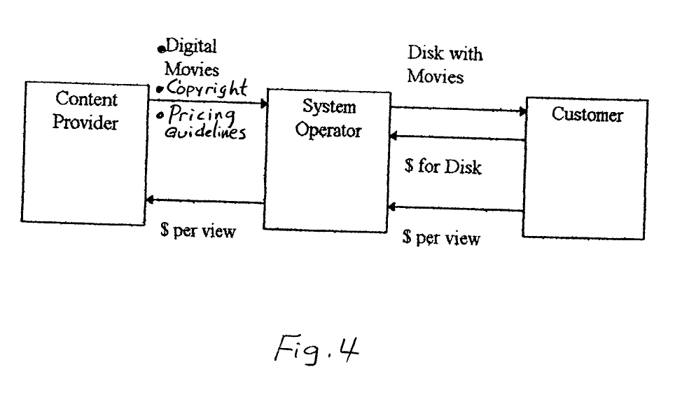

The present invention provides flexibility with respect to the business model to be used to commercialize the invention. In one simplified embodiment, shown in block diagram form in FIG. 4, the video distribution system operator interfaces with two parties: content providers and customers. The content providers provide the content (e.g., movies) to the system operator along with necessary copyright license and pricing guidelines. The system operator places multiple movies securely on disks in collections that maximize the probability that a customer will view several of the movies on the disk. The system operator may also add advertising to the disk for additional movies on this or other disks and other products. The system operator also optionally underwrites the operation of the entire system, provides the invoicing system and makes reader boxes available to customers. Customers are people who attach themselves to the system, most commonly by joining to acquire a reader box. Customers may be enticed to join through a club membership much like in a record club by paying some relatively small initial fee. The system operator sends the customers' disks. Customers pay the system operator for the opportunity to view a movie on the disk. The system operator then pays the content providers according to contracts mostly based upon the number of times a movie was watched and the age and popularity of the movie.

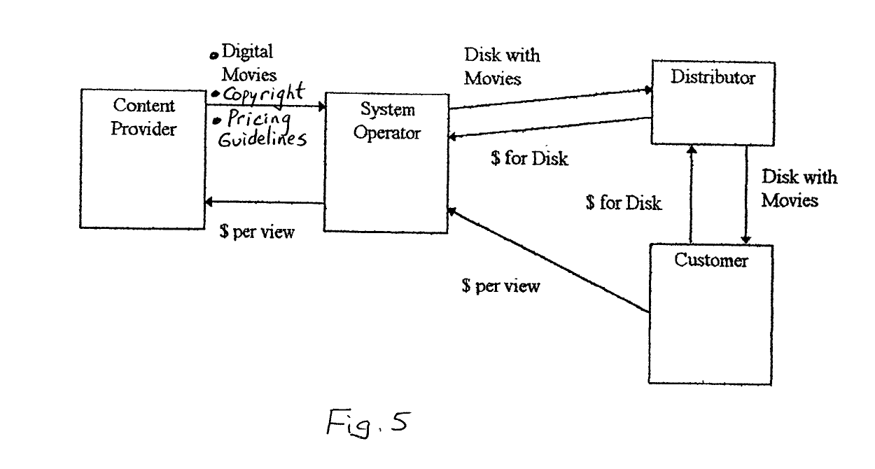

FIG. 5 shows a more complex system where various distributors are used to get movie disks in the hands of customers. Distributors may be large chain stores, like Walmart, smaller local stores like a convenience store, or even an individual person who distributes. Here, the system operator may bulk ship pressed disks to the distributor and charge the distributor an amount that may be greater than or less than the cost of the media, recording and shipping, according to a method that maximizes the probability that individuals will acquire disks that they will play. Similarly, the customer may pay a fee for the disk that is usually more than the cost of the disk to the distributor. In the case of a convenience store, the store may pay $0.30 per disk and sell each disk of ten movies for $1.00. Obviously, distributors may sell disks for less than they paid for them in promotional efforts for another product. When a movie is viewed, the viewer's payment goes directly to the system operator and not the distributor, although system operators may reward distributors for situations in which large numbers of movies on disks they distributed are viewed.

It will be appreciated that the invention may be carried out in conjunction with other distribution strategies for delivering content to the customer households. In this regard, the invention may be carried out in conjunction with a digital movie distribution system whereby movies are blanket broadcast by direct broadcast satellite, cable or other means to set-top boxes that record movies according to the customer's dictates or preferences, thus giving the customer the option of receiving content in the form of physical delivery of movie disks or by digital download to his set-top box. Digital movie distribution systems that may be used in conjunction with this invention are described in commonly assigned U.S. patent application Ser. No. 09/385,671, filed Aug. 27, 1999; Ser. No. 09/436,281, filed Nov. 8, 1999; Ser. No. 09/476,078, filed Dec. 30, 1999; Ser. No. 09/502,069, filed Feb. 10, 2000; Ser. No. 09/553,524, filed Apr. 20, 2000; Ser. No. 09/645,087, filed Aug. 24, 2000; Ser. No. 09/675,025, filed Sep. 28, 2000; and Ser. No. 09/737,826, filed Dec. 15, 2000. These applications describe various features of video distribution systems that have application to this invention, including various security measures for protecting content. The contents of these applications are incorporated by reference herein in their entirety.

As movie distribution according to this invention moves into the homes of millions of viewers, providing an updated guide and index of what is available in the viewers' home libraries becomes an ever increasing need. To this end, according to the invention, a CD-based in-home entertainment guide may be provided to system customers. The CD-based guide can be updated from the internet, wireless, phone connection, other data transmission, or by physical replacement, enabling the customer to place the guide CD into the reader box and scroll through all the movies available to him, including movie information like pricing, ratings, previews, reviews, rankings, actor and actress information, behind the movie footage, etc. With the guide CD installed, the box will compare the digital rights purchase by the customer, and give the customer a choice of listing all movies available, just the ones he currently has rights for, or any number of other categories, like rating, theme, actor or actress, date, author, etc. The customer puts the guide CD into the box and a graphical menu of his desired information is displayed on the connected TV, video screen, or other monitor source. From this menu, the customer finds out what movies are available and will be given the specific CD number or index where the movie or other entertainment can be found. With this information the customer can easily find the right CD he is interested in. While online TV guides exist, many customers will not have access to digital cable, the internet, or direct broadcast satellite service. In addition, since the present invention does not depend upon broadcast TV, the in-home entertainment guide may represent a significant component of a system designed to achieve overall customer satisfaction and convenience of use.

Additionally, the in-home entertainment guide can be updated with current advertisements that are highlighted based on the customer's current view of the entertainment content. The guide may also become a local ordering vehicle for the customer to easily request new entertainment or entertainment packages via the playback device back-channel over wireless, phone, internet or other communication medium.

Summary of Certain Features of the Invention

It will be appreciated that the present invention provides a significantly superior method of movie distribution by giving away, or selling for a low cost, disks containing up to 20, 50, 100 or more movies that are played in a secure system that charges the customer a viewing fee only for movies they choose to watch. The invention increases the likelihood that a customer's viewing needs will be met and increases the effectiveness of movie marketing. As described above, the invention is made possible in large part by the twin technologies of video compression and high-capacity optical disks that can store multiple movies on a disk.

Distribution of movie disks containing multiple movies is advantageous to the customers, distributors, the content providers and the system operator in many ways, including the following. For the customer, the system allows creating a low-cost library of movies that can be watched at any time. By having multiple movies on a disk, the library is both more compact (useful for taking movies on a vacation) and simpler to access since fewer disks are necessary for a library. Access becomes very simple where 20, 50, 100 or more movies are placed on a disk. For the system operator, multiple-movie disks allows reduced media, packaging, and shipping costs or low-volume, low-cost stockpiling of materials for sale. Intermediate distributors (e.g., convenience stores, movie rental stores) when used, receive revenues for selling the disks. Like the video rental industry, capital costs of creating an outlet are quickly repaid so that the owners of many retail stores, gas stations and convenience stores become distribution points. One of the features of this invention, when distribution includes intermediate distributors, is the ability to pay or reward a distributor when the customer plays a movie, providing a continuing source of revenue to the owner of a small store and encouraging them to continue their sales effort. Content providers find this system beneficial because it entices a customer to sample or play a movie on a disk selected for another movie. For example, a disk containing the war movie Platoon might also have similar attractions like Deer Hunter, Apocalypse Now, or even a movie from a previous generation like The Dirty Dozen. Thus, the content provider may realize revenues for both the movie that originally attracted the customer as well as other movies including some second tier or older movies that the customer might not otherwise purchase or rent. The system operator can receive revenues from the original sale of the disk and/or a portion of the per-play revenues. The system operator may also chose to place advertising within the disk to allow additional revenues. Because of the large capacity of the disk and communication capabilities of the players, there is the possibility of interactive advertising to be done.

While the present invention has been described in connection with certain illustrated embodiments and terminology, it will be appreciated that modifications may be made without departing from the true spirit and scope of the invention. In this regard, the term “movies” as used herein is deemed to encompass not only full-length feature films, but also content such as classic sporting events (e.g., Super Bowls), popular TV series (e.g., episodes of Star Trek or Seinfeld or I Love Lucy), or any other video content suitable for distribution. Similarly, it will be appreciated that the terms “digital movie media”, “digital movie disks”, “movie disks” and the like as used herein are not limited to CD, DVD, CD-like and DVD-like optical disks, but may encompass other optical media as well as magnetic and other media suitable to store movies in digital form.

That which is claimed:

1. A method of distributing movies to customer households comprising the steps of:
under authority of content providers who control the distribution rights to movies, on an ongoing periodic basis (e.g., monthly) producing digital movie disks that contain multiple new release movies recorded in accordance with a proprietary digital rights management protocol and also producing digital movie disks that contain multiple classic/older movies also recorded in accordance with a proprietary digital rights management protocol;
providing customer households with movie disk reader devices having means for playing back movies from the movie disks in accordance with the proprietary digital rights management protocol;
distributing the new release movie disks to movie customers on a periodic (e.g., monthly) basis and permitting customers to order selected ones of the classic/older movie disks; and
permitting customers to view desired movies from the new release disks or the classic/older movie disks through their movie disk reader devices with the customers paying a viewing fee only for movies that are actually viewed.
